(19) United States
(12) Patent Application Publication
(10) Pub. No.: US 2017/0041171 A1
(43) Pub. Date: Feb. 9, 2017

(54) Bandwidth and sub-channel indication

(71) Applicant: Intel IP Corporation, Santa Clara, CA (US)

(72) Inventors: Qinghua Li, San Ramon, CA (US); Xiaogang Chen, Beijing (CN); Robert Stacey, Portland, OR (US); Yuan Zhu, Beijing, CA (US); Hujun Yin, Saratoga, CA (US)

(21) Appl. No.: 14/757,829

(22) Filed: Dec. 26, 2015

Related U.S. Application Data
(60) Provisional application No. 62/200,368, filed on Aug. 3, 2015.

(51) Int. Cl. H04L 27/26

(52) U.S. Cl. CPC H04L 27/2608; H04W 84/12

(57) ABSTRACT

This disclosure describes methods, apparatus, and systems related to a bandwidth and sub-channel indication system. A device may determine a wireless communication channel with a first device in accordance with a wireless communication standard. The device may generate a high efficiency frame in accordance with a high efficiency communication standard the high efficiency frame including, at least in part, one or more high efficiency signal fields. The device may determine one or more indication bits included in at least one of the one or more high efficiency signal fields. The device may cause to send the high efficiency frame to the first device over the wireless communication channel.

### CROSS-REFERENCE TO RELATED APPLICATIONS

This application claims the benefit of U.S. Provisional Application No. 62/200,368 filed Aug. 3, 2015 the disclosure of which is incorporated herein by reference as if set forth in full.

### TECHNICAL FIELD

This disclosure generally relates to systems and methods for wireless communications and, more particularly, to a bandwidth and sub-channel indication system in wireless communications.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation.

### BRIEF DESCRIPTION OF THE DRAWINGS

FIG. 1 depicts a network diagram illustrating an example network environment of an illustrative bandwidth and sub-channel indication system, according to one or more example embodiments of the disclosure.

FIG. 2 depicts an illustrative schematic diagram of a contiguous channel.

FIG. 3 depicts an illustrative schematic diagram of a non-contiguous channel in a bandwidth and sub-channel indication system, in accordance with one or more example embodiments of the present disclosure.

FIG. 4 depicts an illustrative schematic diagram of a bandwidth and sub-channel indication system, in accordance with one or more example embodiments of the present disclosure.

FIG. 5 depicts an illustrative schematic diagram of a bandwidth and sub-channel indication system, in accordance with one or more example embodiments of the present disclosure.

FIG. 6A depicts a flow diagram of an illustrative process for an illustrative bandwidth and sub-channel indication system, in accordance with one or more embodiments of the disclosure.

FIG. 6B depicts a flow diagram of an illustrative process for an illustrative bandwidth and sub-channel indication system, in accordance with one or more embodiments of the disclosure.

FIG. 7 illustrates a functional diagram of an example communication station that may be suitable for use as a user device, in accordance with one or more example embodiments of the disclosure.

FIG. 8 is a block diagram of an example machine upon which any of one or more techniques (e.g., methods) may be performed, in accordance with one or more embodiments of the disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In legacy Wi-Fi systems (e.g., IEEE 802.11 a/g/n/etc.), a communications channel between two or more devices may be contiguous in frequency. A contiguous frequency channel is a channel that contains one or more subchannels that are adjacent to each other as opposed to a non-contiguous frequency channel, which may contain one or more subchannels separated by one or more frequency gaps. In recent Wi-Fi systems, non-contiguous channel allocation may be implemented. Within an 80 MHz frequency band, there may be one or more 20 MHz subchannels. A device may use one or more of these 20 MHz subchannels when communicating with another device. In certain conditions, the device may determine that one of the 20 MHz subchannel is unusable. Some of these conditions may be due to interference caused by nearby device operating on the same subchannel, adjacent channels, noise, obstacles, or the like. The remaining usable 20 MHz subchannels may form a contiguous or non-contiguous channel. However, in case of one or more unusable 20 MHz subchannels, the transmitting device may need to inform the receiving device of which 20 MHz subchannels are used for the transmission. This may require an indication scheme for signaling the non-contiguous frequencies to the receiving device in order to assist the receiving device in determining which subchannels are used.

Example embodiments of the present disclosure relate to systems, methods, and devices for bandwidth and sub-channel indications. During a communication session between multiple devices, a transmitting device may occupy multiple 20 MHz subchannels in a variety of frequency bands (e.g., 40/80/160 MHz bands, etc.) of a communication channel. In one embodiment, bandwidth indication of device allocation may need to be extended for the per-20 MHz encoding. For example, a device may utilize one or more fields within the preamble of a data or control or management packet (e.g., HE-SIG-A field in a high-efficiency preamble) to indicate which 20 MHz subchannel(s) are used. In one embodiment, a transmitting device may allocate a number of bits used within the HE-SIG-A field (e.g., 3 to 7 bits) to indicate which 20 MHz subchannels are used. In another embodiment, after determining that one or more 20 MHz subchannels are not used, the transmitting device may reduce the size of the common part of the HE-SIG-B field. For example, the transmitting device may reduce the size of the common part of the HE-SIG-B field when the total channel bandwidth is reduced e.g. from primary 80 MHz down to primary 40 MHz, where some 20 MHz subchannel in the primary channels may not be usable. In another embodiment, sub-channel groups for two parallel HE-SIG-B encoding streams may be introduced in order to facilitate the indication of resource allocation. In another embodiment, the resource unit (RU) allocation pattern may be extended to cover 484 and 996 tone resource units (RUs).

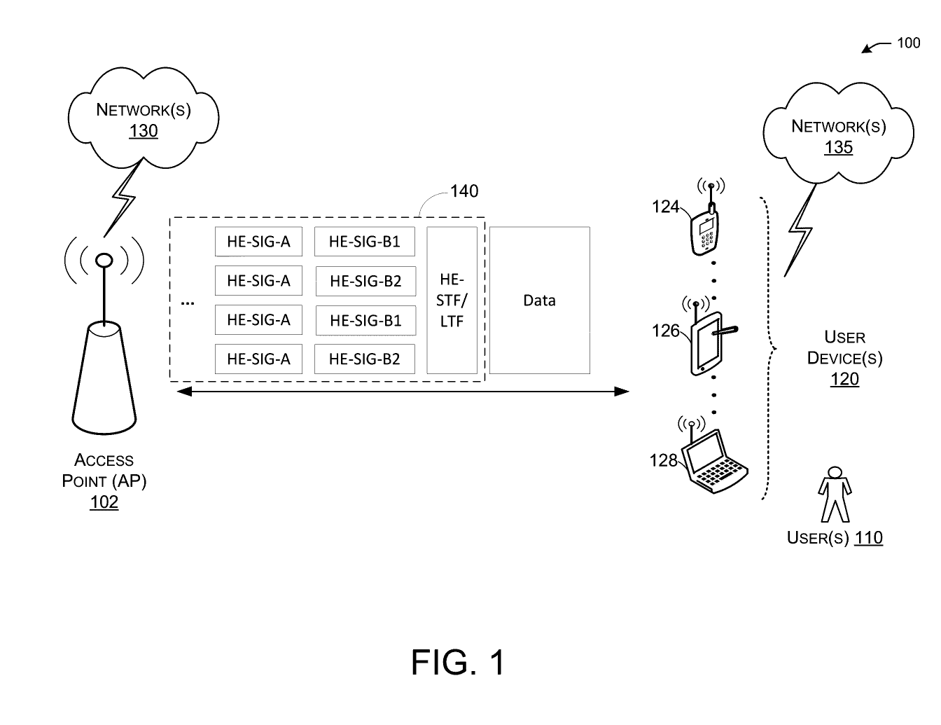

FIG. 1 is a network diagram illustrating an example network environment, according to some example embodiments of the present disclosure. Wireless network 100 can include one or more user devices 120 and one or more access point(s) (AP) 102, which may communicate in accordance with IEEE 802.11 communication standards, including IEEE 802.11ax (HEW). The user device(s) 120 may be mobile devices that are non-stationary and do not have fixed locations.

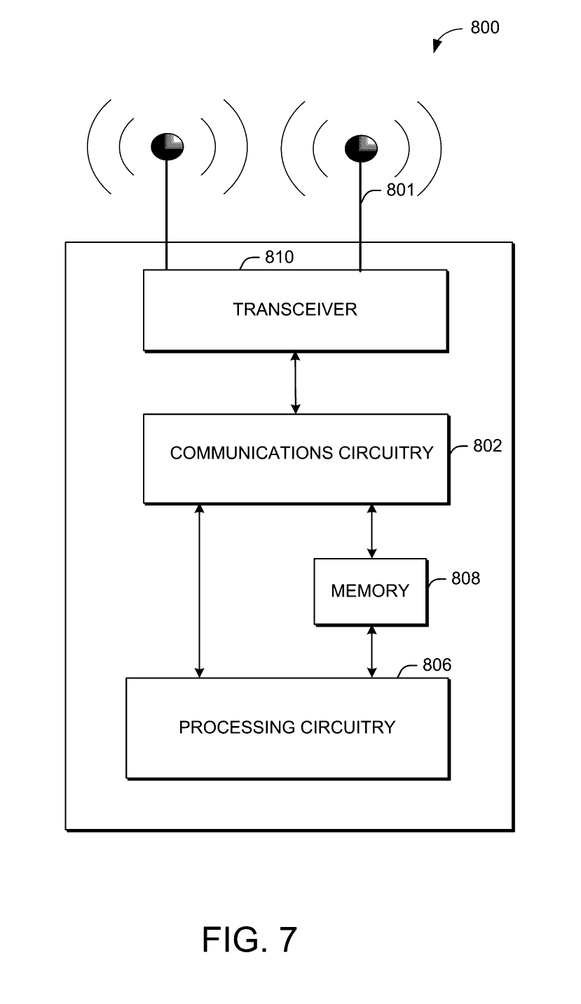

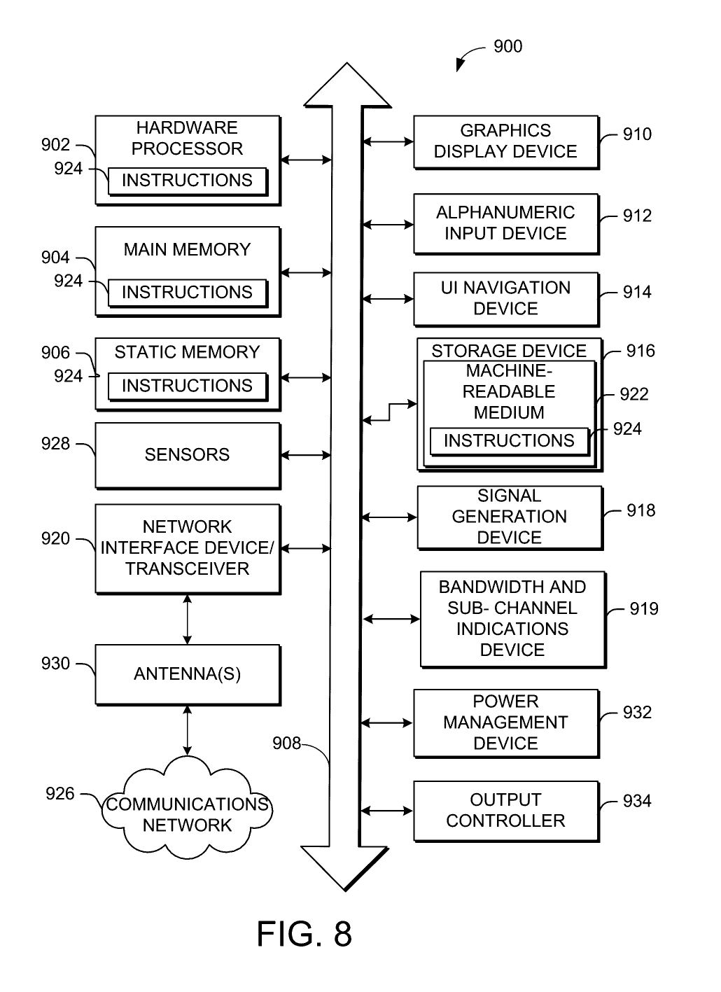

In some embodiments, the user devices 120 may include one or more computer systems similar to that of the functional diagram of FIG. 7 and/or the example machine/system of FIG. 8.

One or more illustrative user device(s) 120 may be operable by one or more user(s) 110. The user device(s) 120 (e.g., 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

When an AP (e.g., AP 102) establishes communication with one or more user devices 120 (e.g., user devices 124, 126, and/or 128), the AP 102 may communicate in a downlink direction and the user devices 120 may communicate with the AP 102 in an uplink direction by sending data frames in either direction. The data frames may be preceded by one or more preambles that may be part of one or more headers. These preambles may be used to allow a device (e.g., AP 102 and/or user devices 120) to detect a new incoming data frame from another device. A preamble may be a signal used in network communications to synchronize transmission timing between two or more devices (e.g., between the APs and user devices).

In one embodiment, and with reference to FIG. 1, an HEW preamble (e.g., preamble 140) may include at least in part, a high efficiency signal field A (HE-SIG-A), a high efficiency signal field B (HE-SIG-B), a high efficiency short training field (HE-STF), a high efficiency long training field (HE-LTF), and one or more data fields that may contain the data to be transmitted from one device to another. It is understood that the above acronyms may be different and not to be construed as a limitation as other acronyms maybe used for the fields included in an HEW preamble.

The fields that may be transmitted between the AP 102 and user devices 120 may utilize one or more subchannels of a frequency band. Referring to FIG. 1, an 80 MHz channel having four 20 MHz subchannels is depicted. Some of these 20 MHz subchannels may be unusable. In that case, the frequency band may be punctured and may be considered to be a non-contiguous channel. However, if all the 20 MHz subchannels are usable, then the frequency band may be considered contiguous. It is understood that contiguous channel indicate that there is no gap between the one or more subchannels used for the transmission of data between two devices (e.g., between AP 102 and user device(s) 120). Further, the subchannels of the frequency band (e.g., 20 MHz subchannels) may be designated as primary or secondary subchannels. A primary channel is first established between devices, and the secondary channel adds a subchannel (e.g., 20 MHz) to the primary channel to make a larger channel. The secondary channel may be either the channel above or the channel below the primary channel or may be separated by a frequency gap.

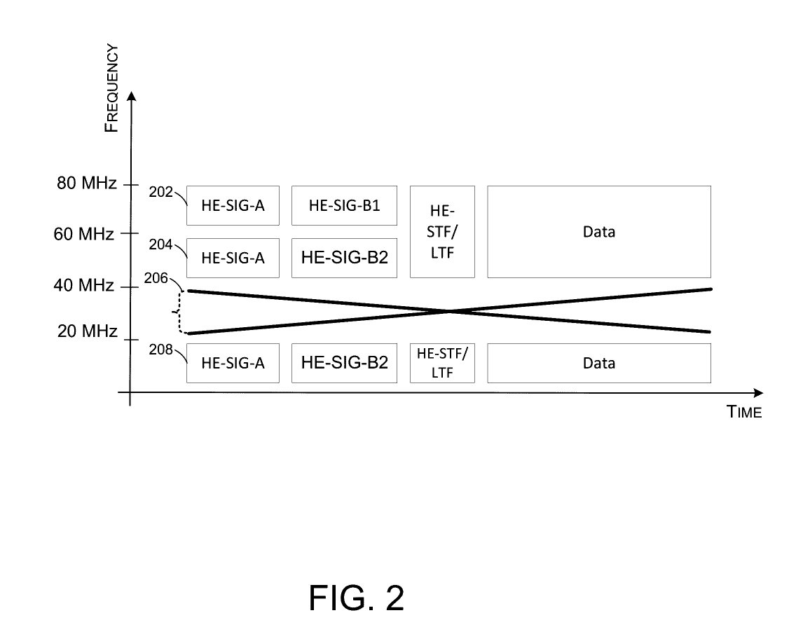

FIG. 2 depicts an illustrative schematic diagram of a non-contiguous channel in a bandwidth and sub-channel indication system, in accordance with one or more example embodiments of the present disclosure.

A non-contiguous channel signifies that within a frequency band, at least one of the subchannels of that frequency band is unusable. A subchannel that is unusable within the one or more subchannels of a frequency band may be due to interference from various sources, such as, adjacent channels, noise, obstacles, etc . . . In the example of FIG. 2, a 20 MHz subchannel may be removed or punctured out (e.g., subchannel 206) because the subchannel may be unusable. Although the unusable 20 MHz subchannel may be punctured out, some information may still be sent on that subchannel. That is, on the punctured 20 MHz subchannel, there may be no data signal being sent but preamble signals such as HE-SIG-A, HE-SIG-B, and HE-STF and HE-LTF may be sent.

In one embodiment, a transmitting device may need to signal the receiving device which 20 MHz subchannels are used (e.g., 20 MHz subchannels 202, 204 and 208) for data transmission. In order to indicate that 20 MHz subchannels 202, 204 and 208 are used, an indication may need to be sent to the receiving device. For example, for signaling the used 20 MHz subchannels in a physical layer convergence protocol (PLCP) protocol data unit (PPDU), indication bits may be placed in HE-SIG-A such that the receiving device may be able to determine which 20 MHz subchannels are used. The HE-SIG-A content may be encoded within any 20 MHz subchannel (20 MHz subchannels 202, 204 or 208) and repeated on all used 20 MHz subchannels. Since 80 MHz may be a mode used in 802.11ax (HEW), the primary 20 MHz subchannel may be known by each device (e.g., user devices 120) in the coverage area, where each device may listen for the primary subchannel. The transmitting device may acquire a primary 20 MHz subchannel for each transmission to a receiving device and vice versa. Therefore, there may be no need to indicate the presence of the primary 20 MHz subchannel. That is, the transmitting device may not need to notify the receiving device that the primary 20 MHz subchannel is used. In an 80 MHz frequency band, there may be a need for 3 bits to indicate the presence of the other three secondary 20 MHz subchannels (e.g., one bit for each used subchannel).

In one embodiment, for a 160 MHz channel, there may be two options for indicating to a receiving device which 20 MHz subchannels are used during data transmission from a transmitting device when only one primary 20 MHz subchannel is used. Since there are eight secondary 20 MHz subchannels in a 160 MHz channel, and no need to notify a transmitting device of the primary charnel, then seven 20 MHz subchannels may possibly need to be indicated to a receiving device. Consequently, a transmitting device may need to utilize around 7 bits to indicate the presence of the 7 secondary 20 MHz subchannels. These indication bits may be part of the HE-SIG-A field of the preamble sent from a transmitting device to a receiving device. However, utilizing 7 bits within the HE-SIG-A field may incur additional overhead in the HE-SIG-A field.

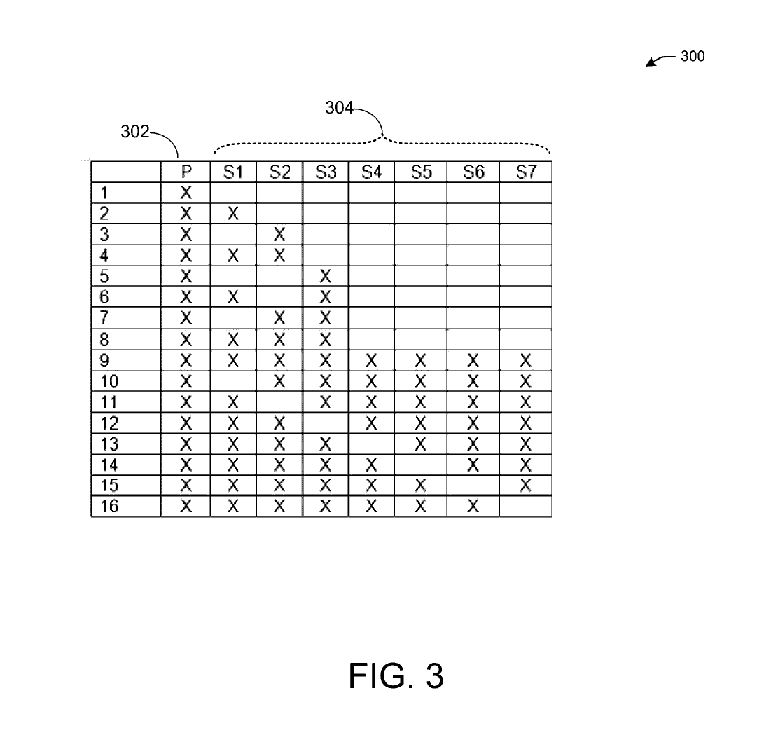

FIG. 3 depicts an illustrative Table 300 for subchannel configuration, in accordance with one or more example embodiments of the present disclosure.

In another embodiment, a subchannel configuration table (e.g., Table 300) may be defined that accounts for a subset of useful configurations that may be used to indicate to the receiving device which 20 MHz subchannel is used or not used. This may result in a lower number of indication bits since not all configurations are reported in Table 300. Consequently, the number of configuration bits may be less than 7 bits (e.g., 4 or 5 bits). For example, since 4 bits provides 16 possible combinations (e.g., 0000, 0001, 0010, 0011, 0100, 0101, 0110, 0111, 1000, 1001, 1010, 1011, 1100, 1101, 1110, and 1111), the transmitting device may be able to indicate using these four bits up to 16 possible usages of 20 MHz subchannels.

In one embodiment, a bandwidth subchannel indication system may allocate one or more indication bits of the HE-SIG-A field to be used as an indication of the bandwidth of the transmission and/or an indication of the subchannels that are used and/or not used for the transmission. The bandwidth indication may have the same format for all channel band sizes (e.g., 20/40/80/160 MHz channel bands) since the receiving device (e.g., AP 102 and/or user devices 120 of FIG. 1) may not know the bandwidth before decoding the HE-SIG-A field. Therefore, the bandwidth indication format may remain constant for all channel band sizes. For example, around 3-7 bits may be used for bandwidth indication. If 4 bits is used, eight out of the 16 configurations may the same since all possible 20 MHz subchannel configurations in an 80 MHz channel may be indicated by 3 bits. The eight configurations may be enough to cover configurations associated with 20/40/80 MHz frequency bands. On the other hand, frequency bands higher than the 80 MHz frequency may not be completely represented using 4 bits.

Table 300 shows an example of 4-bit indication that may be used by a transmitting device (e.g., AP 102 and/or user devices 120 of FIG. 1) to notify a receiving device (e.g., AP 102 and/or user devices 120 of FIG. 1) of which subchannels are used or not used. Table 300 may be used for indicating the usage of 20 MHz subchannels in any of 20/40/80/160 frequency bands. Column 302 shows the primary subchannel usage, where P denotes the primary 20 MHz subchannel. Columns 304, show the usage of seven 20 MHz secondary subchannels, where S_{1, . . . 7} denotes each of the secondary 20 MHz subchannel. Further, each entry in Table 300 shows whether a 20 MHz subchannel is used or not, where X denotes a used subchannel in the configuration and a blank entry denotes that a subchannel is not used. In this example, the primary 20 MHz subchannel is assumed to be always used in the configuration. Hence, each entry in Table 300 shows an X under the P column. In the example, P and S1 form the primary 40 MHz channel; P, S1, S3, and S4 for the primary 80 MHz channel.

In one embodiment, for a 160 MHz channel, if there are two primary 20 MHz subchannels, then the 3-bit design for 80MHz channel may be reused here. The 160 MHz channel may be divided into two 80 MHz subchannels, each of which has a primary 20 MHz subchannel that the receiving device may listen to. The bandwidth indication fields of the two primary 20 MHz subchannels may be different and independent.

In one embodiment, the size of the common part of the HE-SIG-B field may be reduced. The size of HE-SIG-B may be reduced after a puncturing out of subchannel. For example, the transmitting device may reduce the size of the common part of the HE-SIG-B field when the total channel bandwidth is reduced e.g. from primary 80 MHz down to primary 40 MHz, when some 20 MHz subchannel in the primary channels are not be usable. The common part size varies with the total used bandwidth in the corresponding subchannel group. Each subchannel group has its common part. 20 MHz channel has one subchannel group. 40 MH channel has two subchannel groups. 80 and 160 MHz channels have two subchannel groups. The common part in 80 MHz subchannel group should be longer than that in 40 MHz subchannel group even though some 20 MH subchannel may not be used. This simplifies the implementation because the common part only varies with the total bandwidth not total used bandwidth. For example, the common part has 8 bits for RU allocation for each 20 MHz subchannel in the subchannel group regardless whether the subchannel is used or not. For example, after a 20 MHz subchannel is punctured out (e.g., not used), the indication for resource unit (RU) allocation may be simplified, which may result in a reduction in overhead. For example, each 20 MHz subchannel may take about 8-9 bits for RU allocation that partitions the frequency bandwidth into RUs and may allocate the RUs to users. If a 20 MHz subchannel is not used, then the usable bandwidth may reduce and the number of indication bits for RU allocation may be reduced by about 8-9 bits. The RU allocation bits may be in the common part of HE-SIG-B.

In some embodiments, there may be no common part in HE-SIG-B. For example, the RU allocation indication may be in the user's specific part. Because the subchannel puncturing may reduce the usable bandwidth, the indication bits for the per-user RU allocation may be reduced accordingly. Each 20 MHz subchannel may include about 16 different per-user RU allocations. Therefore, the number of RU allocations may be reduced by about 16 after one 20 MHz subchannel is punctured. In some embodiments, the RU allocation is not in HE-SIG-B. Instead, it is the MAC payload of a trigger frame e.g. sent by the AP for scheduling multiuser uplink transmissions. The reduction of allocation bits may be applied to the trigger frame.

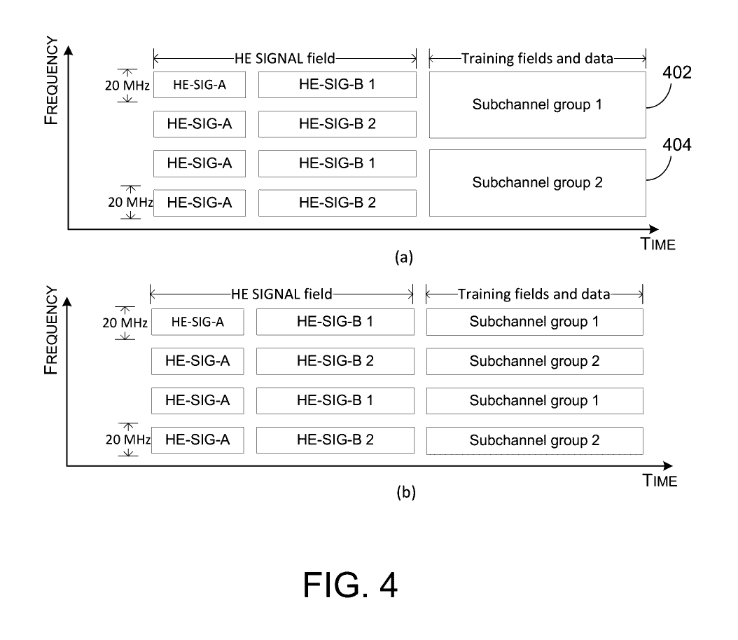

FIG. 4 depicts an illustrative schematic diagram of a bandwidth and sub-channel indication system, in accordance with one or more example embodiments of the present disclosure.

In one embodiment, the channel may be divided into two or more subchannel groups. For example, in an 80 MHz frequency band, there may be four 20 MHz subchannels. One or more of the four 20 MHz subchannels may form a subchannel group. For example, two subchannel groups (e.g., subchannel groups 402 and 404), may each include two 20 MHz subchannels. However, the 20 MHz subchannels of each subchannel group 402 and/or 404 may be contiguous or non-contiguous. Each subchannel group 402 and/or 404 may be indicated by an allocation within the HE-SIG-B stream. That is, subchannel group 1 is indicated by HE-SIG-B1 and subchannel group 2 is indicated by HE-SIG-B 2. HE-SIG-B1 may contain information, such as, resource allocation, user device ID, and modulation encoding scheme (MCS) for subchannel group 1 (e.g., subchannel group 402), and HE-SIG-B 2 may contain information for subchannel group 2 (e.g., subchannel group 404).

In one embodiment, the one or more subchannel groups may be indicated by HE-SIG-B streams from different 20 MHz subchannels. For example, FIG. 4(a) shows a contiguous subchannel group. For FIG. 4(a), one copy of the HE-SIG-B. stream may be in the same subchannel group as the corresponding data but the other copy of HE-SIG-B stream may be in the other subchannel group. For example, the HE-SIG-B 1 stream is in a subchannel of the subchannel group 1 and subchannel group 2. The HE-SIG-B 2 stream is in a subchannel of the subchannel group 1 and subchannel group 2.

In one embodiment, a HE-SIG-B stream and the data resource units (RUs) allocated by the HE-SIG-B stream are within the same frequency subchannel or subchannel group. For example, FIG. 4(b) shows the HE-SIG-B stream and the corresponding data allocated by the HE-SIG-B stream are within the same subchannel group. In that case HE-SIG-B 1 is always in the same subchannel as subchannel group 1 and HE-SIG-B 2 is in subchannel group 2. In the presence of interference, if the data selects one subchannel group, so does the corresponding HE-SIG-B stream.

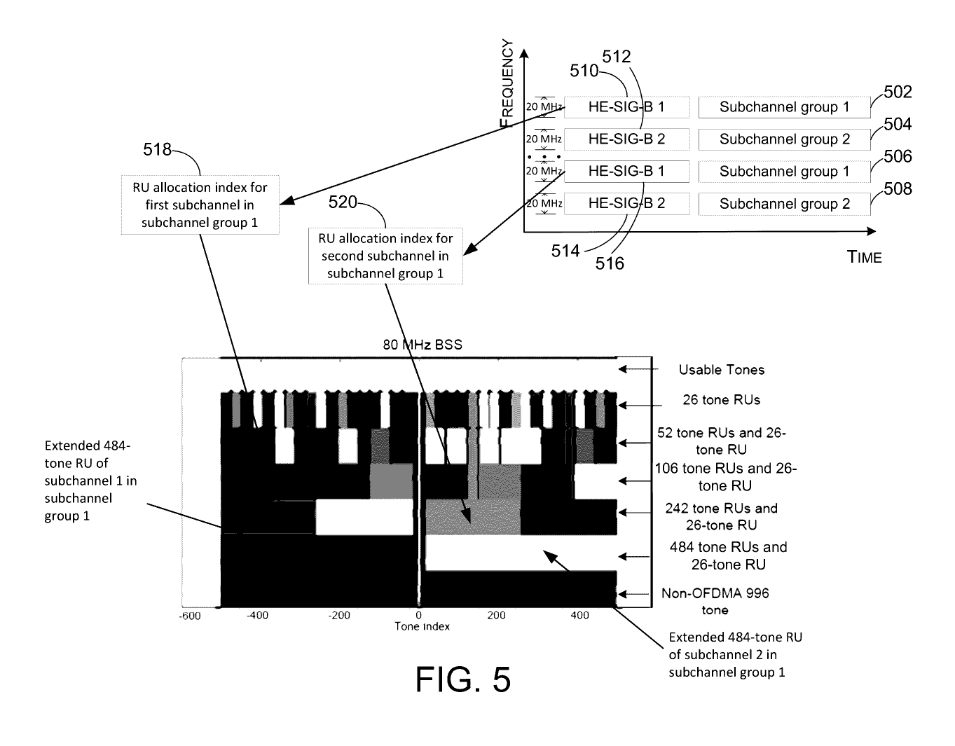

FIG. 5 depicts an illustrative schematic diagram of a bandwidth and sub-channel indication system, in accordance with one or more example embodiments of the present disclosure.

In one embodiment, a bandwidth and subchannel indication system may facilitate the indication of one or more resource units (RUs) allocations that may be used during a data transmission between a transmitting device (e.g., AP 102 and/or user devices 120 of FIG. 1) and a receiving device (e.g., AP 102 and/or user devices 120 of FIG. 1).

In one embodiment, the channel may be divided into two or more subchannel groups. There are four 20 MHz subchannels used in the example of FIG. 5. One or more of the four 20 MHz subchannels may form a subchannel group. For example, two subchannel groups (e.g., subchannel groups 1 and subchannel group 2), may each include two 20 MHz subchannels. For example subchannel group 1 is represented by group 502 and 506 and subchannel group 2 is represented by groups 504 and 508. Each subchannel group (e.g., subchannel groups 1 or subchannel group 2) may be indicated by an allocation within the HE-SIG-B stream. That is, subchannel group 1 is indicated by HE-SIG-B 1 and subchannel group 2 is indicated by HE-SIG-B 2. HE-SIG-B1 may contain information, such as, RUs allocations for subchannel group 1 and HE-SIG-B 2 may contain information such as, RUs allocations for subchannel group 2.

In one embodiment, each HE-SIG-B stream may carry RU allocation information for the respective subchannel group. For example, the HE-SIG-B 1 field 510 may carry the RU allocation information for subchannel group 1502, the HE-SIG-B 2 field 512 may carry the RU allocation information for subchannel group 2 504, the HE-SIG-B 1 field 514 may carry the RU allocation information for subchannel group 1 506, and the HE-SIG-B 2 field 516 may carry the RU allocation information for subchannel group 2 508. Since there may be two 20 MHz subchannels in each subchannel group, two RU allocation indices (e.g., index 518 and index 520) may be used for the two 20 MHz subchannels, respectively. Index 518 and index 520 may be around 5-9 bits. Each RU allocation index may be used to indicate how a 20 MHz subchannel is comprised based on allocated RUs. For another example, the HE-SIG-B 1 field 510 may carry the RU allocation information for both subchannel group 1 502 and subchannel group 1 506, the HE-SIG-B 2 field 512 may carry the RU allocation information for both subchannel group 2 504 and subchannel group 2 508. The HE-SIG-B 1 field 510 and field 512 may be the same. The HE-SIG-B 2 field 512 and field 514 may be the same. Since there may be two 20 MHz subchannels in each subchannel group, two RU allocation indices (e.g., index 518 and index 520) may be used for the two 20 MHz subchannels, respectively. Index 518 and index 520 may be around 5-9 bits. Each RU allocation index may be used to indicate how a 20 MHz subchannel is comprised based on allocated RUs. The two RU allocation indexes may be all in both field 510 and field 516.

In one embodiment, the RU allocation index may specify the allocated RU sizes and locations of the corresponding subchannel. For example, the 20 MHz subchannel may be allocated as a whole piece to a single user in a single user (SU) mode or multiple users in a multi-user user multiple-input multiple-output (MU-MIMO) mode. In another example, the 20 MHz subchannel may be comprised of a number of RUs with various RU sizes (e.g., 26 tone RU, 52 tone RU, 106 tone RU). For example, a 20 MHz subchannel may be comprised of nine 26 tone RUs, four 52 tone RUs and one 26 tone RU, two 106 tone RUs and one 26 tone RU, one 242 tone RU, etc. In addition, a 20 MHz subchannel may be comprised of any combination of the various tone RUs. It should be understood that some RUs that are part of a subchannel may not be allocated to any user device. For example, a 26-tone RU included in a subchannel may not be allocated to any user device, but other RUs may be assigned to user devices within that subchannel. Namely, the RU allocation pattern may be indicated by the allocation index (e.g., index 518 and 520) and the allocation patterns may include full allocation and/or partial allocation.

In one embodiment, the RU allocation index in HE-SIG-B i, where i=1 or 2 in the example of FIGS. 4 and 5 may allocate an RU greater than 20 MHz, e.g., 484-tone RU and 996-tone RU. In this case, the allocated RU may be the following RU. First, it may have the allocated size e.g. 484-tone. Second, the allocated RU may include the 20 MHz subchannel that RU allocation index may be used for. For the example in FIG. 5, the RU allocation index 518 is used primarily for the 20 MHz subchannel on the left most of the band. If index 518 allocates a 242-tone RU, the RU may be the 242-tone RU on the left most of the band. If index 518 allocates a 484-tone RU, the RU may be the 484-tone RU on the left most of the band. If index 518 allocates a 996-tone RU, the RU may be the whole 80 MHz band.

In some embodiments, the RU allocation may include RU allocation for 484 and 996 tone RUs. Namely, the RU index is primarily for 20 MHz subchannel 1. When the RU index indicates or allocates a RU greater than 242 tone RU, such as for 20 MHz, (e.g., 484 or 996 tone RU), the allocated RU (e.g. 484 or 996 tone RU) may cover the 20 MHz subchannel that the RU index is primarily for. In addition, the extended RU may be one of the available extended 484-tone in FIG. 5. The valid RUs for 80 MHz are listed in FIG. 5 and the valid RUs for 20/40/80 MHz are listed in the figures below. The ones for 160 MHz are not shown but are defined in the spec. For example, the extended RU may be valid (e.g., defined in the IEEE 802.11 specifications) and must include the 20 MHz subchannel the index is primarily used for.

It is understood that the above are only examples, and that other allocation may be possible.

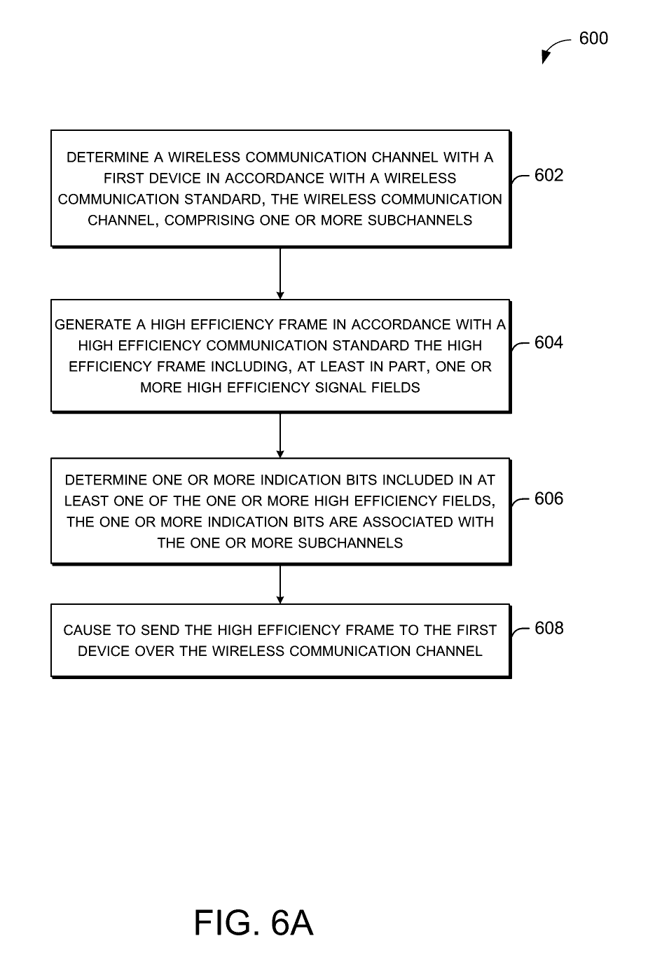

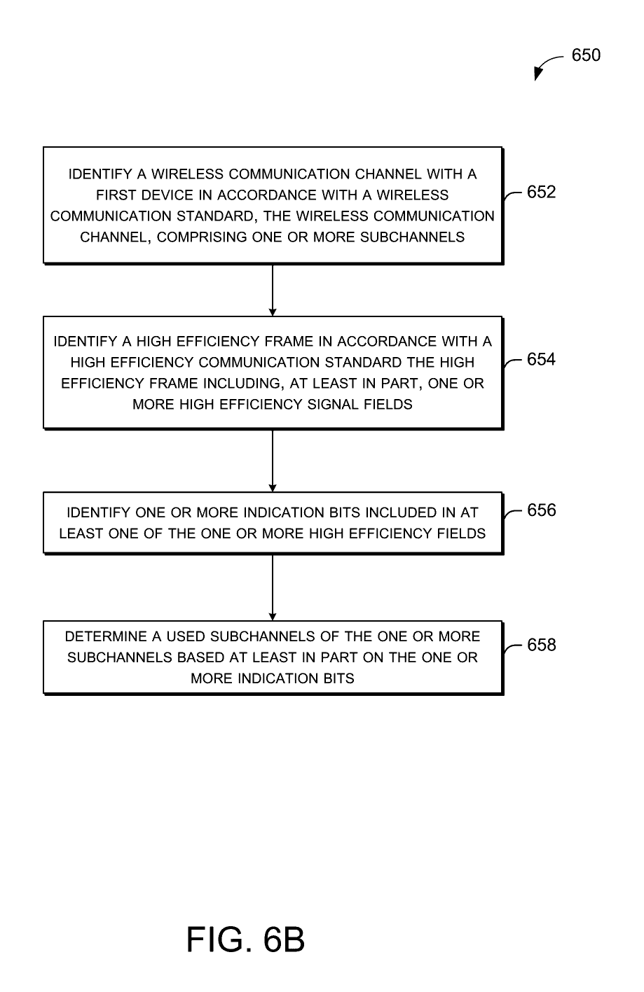

FIG. 6A illustrates a flow diagram of illustrative process 600 for a bandwidth and sub-channel indication system, in accordance with one or more embodiments of the disclosure.

At block 602, a device (e.g., AP 102 or user device 120 of FIG. 1) may determine a wireless communication channel with a first device in accordance with a wireless communication standard, the wireless communication channel, comprising one or more subchannels. The wireless communication channel may be a non-contiguous channel or a contiguous channel. A non-contiguous frequency channel may contain one or more subchannels separated by one or more frequency gaps. Within a contiguous 80 MHz band, there may be one or more 20 MHz subchannels that a device may or may not use. The device may determine that one of the 20 MHz subchannel is unusable due to various factors such as interference. Typically, the one or more subchannels of a frequency channel may include a primary sub-channel and one or more secondary sub-channels.

At block 604, the device may generate a high efficiency frame in accordance with a high efficiency communication standard the high efficiency frame including, at least in part, one or more high efficiency signal fields. The one or more high efficiency signal fields include at least one of a high efficiency signal A (HE-SIG-A) field and a high efficiency signal B (HE-SIG-B) field. High-efficiency signaling between one or more devices may be split into two fields, the HE-SIG-A field and the HE-SIG-B field. Taken together, the two fields may describe the included frame attributes such as the channel width, modulation and coding, and whether the frame is a single- or multi-user frame. The HE-SIG-A field comes first in a high-efficiency frame. Its format may depend on whether the transmission is single-user or multi-user. It is comprised of two parts, each of which corresponds to an OFDM symbol, are referred to as HE-SIG-A1 and HE-SIG-A2. The HE-SIG-B field may be used to set up the data rate, as well as tune in MIMO reception.

At block 606, the device may determine one or more indication bits included in at least one of the one or more high efficiency fields, the one or more indication bits are associated with the one or more subchannels. For example, a device may determine that one of the 20 MHz subchannel is unusable due to various factors such as interference, where the remaining usable 20 MHz subchannels may form a contiguous or non-contiguous channel. However, in case there are one or more unusable 20 MHz subchannels, the transmitting device may need to inform the receiving device of which 20 MHz subchannels are used for the transmission. The one or more indication bits may be used to inform the receiving device of such subchannels. The one or more indication bits are included in the HE-SIG-A field. The device may determine one or more RUs associated with the at least one used subchannel. In some examples, the HE-SIG-B stream may carry RU allocation information for the respective subchannel group. The subchannel group may be a group of subchannels within the transmission channel. The indication of the RU allocation may be encoded within a RU allocation index that may be part of the HE-SIG-B. The RU allocation index may inform the receiving device of what tone RUs are used. For example, a 20 MHz subchannel may utilize a combination of 26-tone RUs, 52-tone RUs, and 106-tone RUs. That information may be encoded in the RU allocation index in the HE-SIG-B at the transmitting device. That information may be then decoded at the receiving device in order to determine the RU allocation information of the respective subchannel group. In case a subchannel being unused (punctured out), the RU allocation index may be different than if all the subchannels are used. The RU allocation index may require reduced number of bits within the HE-SIG-B, therefore the size of the HE-SIG-B field may be modified based on that information.

In some examples, the device may determine a subchannel configuration list of at least one of the one or more subchannels, wherein the subchannel configuration list includes a predetermined subset of used subchannels within the wireless communication channel. The subchannel configuration list may be a table that accounts for a subset of useful configurations that may be used to indicate to the receiving device which 20 MHz subchannel is used or not used. This may result in a lower number of indication bits since not all configurations are reported in the table. For example, in an 80 MHz channel, there may be four 20 MHz subchannel. In order to determine which subchannel is used or not used, a seven indication bits may be necessary to cover all possible configuration. However, the table may contain a lower number of indication bits covering a subset of useful configurations that may be used to indicate to the receiving device which 20 MHz subchannel is used or not used.

At block 608, the device may cause to send the high efficiency frame to the first device over the wireless communication channel.

FIG. 6B illustrates a flow diagram of illustrative process 650 for a bandwidth and sub-channel indication system, in accordance with one or more embodiments of the disclosure.

At block 652, a device (e.g., AP 102 or user device 120 of FIG. 1) may identify a wireless communication channel with another device (e.g., AP 102 or user device 120 of FIG. 1) in accordance with a wireless communication standard, the wireless communication channel, comprising one or more subchannels. The wireless communication channel may be a non-contiguous channel or a contiguous channel. A non-contiguous frequency channel may contain one or more subchannels separated by one or more frequency gaps. Within a contiguous 80 MHz band, there may be one or more 20 MHz subchannels that a device may or may not use. The device may determine that one of the 20 MHz subchannel is unusable due to various factors such as interference. Typically, the one or more subchannels of a frequency channel may include a primary sub-channel and one or more secondary sub-channels.

At block 654, the device may identify a high efficiency frame in accordance with a high efficiency communication standard the high efficiency frame including, at least in part, one or more high efficiency signal fields. The one or more high efficiency signal fields include at least one of a high efficiency signal A (HE-SIG-A) field and a high efficiency signal B (HE-SIG-B) field. High-efficiency signaling between one or more devices may be split into two fields, the HE-SIG-A field and the HE-SIG-B field. Taken together, the two fields may describe the included frame attributes such as the channel width, modulation and coding, and whether the frame is a single- or multi-user frame. The HE-SIG-A field comes first in a high-efficiency frame. Its format may depend on whether the transmission is single-user or multi-user. The HE-SIG-B field may be used to set up the data rate, as well as tune in MIMO reception.

At block 656, the device may identify one or more indication bits included in at least one of the one or more high efficiency fields. For example, a device may determine that one of the 20 MHz subchannel is unusable due to various factors such as interference, where the remaining usable 20 MHz subchannels may form a contiguous or non-contiguous channel. However, in case there are one or more unusable 20 MHz subchannels, a transmitting device may need to inform the receiving device of which 20 MHz subchannels are used for the transmission. The one or more indication bits may be used to inform the receiving device of such subchannels. The one or more indication bits are included in the HE-SIG-A field. The device may determine one or more RUs associated with the at least one used subchannel. In some examples, the HE-SIG-B stream may carry RU allocation information for the respective subchannel group. The subchannel group may be a group of subchannels within the transmission channel. The indication of the RU allocation may be encoded within a RU allocation index that may be part of the HE-SIG-B. The RU allocation index may inform the receiving device of what tone RUs are used. For example, a 20 MHz subchannel may utilize a combination of 26-tone RUs, 52-tone RUs, and 106-tone RUs. That information may be encoded in the RU allocation index in the HE-SIG-B at the transmitting device. That information may be then decoded at the receiving device in order to determine the RU allocation information of the respective subchannel group. In case a subchannel being unused (punctured out), the RU allocation index may be different than if all the subchannels are used. The RU allocation index may require reduced number of bits within the HE-SIG-B, therefore the size of the HE-SIG-B field may be modified based on that information.

At block 658, the device may determine a used subchannels of the one or more subchannels based at least in part on the one or more indication bits. The indication bits may inform the receiving device whether a subchannel is used or not based on how the indication bits are set by the receiving device. In other examples, the receiving device may determine a subchannel configuration list or table of some of the one or more subchannels. Wherein the subchannel configuration list includes a predetermined subset of used subchannels within the wireless communication channel. The subchannel configuration list may be a table that accounts for a subset of useful configurations that may be used to indicate to the receiving device which 20 MHz subchannel is used or not used. This may result in a lower number of indication bits since not all configurations are reported in the table. For example, in an 80 MHz channel, there may be four 20 MHz subchannel. In order to determine which subchannel is used or not used, a seven indication bits may be necessary to cover all possible configuration. However, the table may contain a lower number of indication bits covering a subset of useful configurations that may be used to indicate to the receiving device which 20 MHz subchannel is used or not used.

FIG. 7 shows a functional diagram of an exemplary communication station 800 in accordance with some embodiments. In one embodiment, FIG. 7 illustrates a functional block diagram of a communication station that may be suitable for use as an AP 102 (FIG. 1) or communication station user device 120 (FIG. 1) in accordance with some embodiments. The communication station 800 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer communications and/or medium access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed in FIGS. 2-6.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device may, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

FIG. 8 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), a bandwidth and sub-channel indications device 919, a network interface device/transceiver 920 coupled to antenna(s) 930, and one or more sensors 928, such as a global positioning system (GPS) sensor, compass, accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The bandwidth and sub-channel indications device 919 may carry out or perform any of the operations and processes (e.g., processes 600 and/or 650). For example, the bandwidth and sub-channel indications device 919 may be configured to indicate the used 20 MHz subchannels in HE-SIG-A using, e.g., 3 or 7 bits. The bandwidth and sub-channel indications device 919 may be configured to reduce the size of HE-SIG-B common after some 20 MHz sub-channel is punctured. The bandwidth and sub-channel indications device 919 may be configured to introduce sub-channel groups for two parallel HE-SIG-B encoding streams. The bandwidth and sub-channel indications device 919 may be configured to extend the resource unit (RU) allocation pattern to cover 484- and 996-tone RUs.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

According to example embodiments of the disclosure, there may be a wireless communication device. The wireless communication device may include at least one memory that stores computer-executable instructions, and at least one processor of the one or more processors configured to access the at least one memory, wherein the at least one processor of the one or more processors is configured to execute the computer-executable instructions to determine a wireless communication channel with a first device in accordance with a wireless communication standard, the wireless communication channel, comprising one or more subchannels. The at least one processor of the one or more processors may be configured to execute the computer-executable instructions to generate a high efficiency frame in accordance with a high efficiency communication standard the high efficiency frame including, at least in part, one or more high efficiency signal fields. The at least one processor of the one or more processors may be configured to execute the computer-executable instructions to determine one or more indication bits included in at least one of the one or more high efficiency fields, the one or more indication bits are associated with the one or more subchannels. The at least one processor of the one or more processors may be configured to execute the computer-executable instructions to cause to send the high efficiency frame to the first device over the wireless communication channel.

Implementations may include one or more of the following features. The wireless communication channel may be a non-contiguous channel or a contiguous channel. The one or more subchannels may include a primary sub-channel and one or more secondary sub-channels. The one or more high efficiency signal fields include at least one of a high efficiency signal A (HE-SIG-A) field and a high efficiency signal B (HE-SIG-B) field. The one or more indication bits may indicate at least one used subchannel of the one or more subchannels within the wireless communication channel. The at least one processor may further be configured to execute the computer-executable instructions to determine one or more resource on units associated with the at least one used subchannel. The at least one processor of the one or more processors may be configured to execute the computer-executable instructions to modify the HE-SIG-B field based at least in part on one or more resource units. The at least one processor is further configured to execute the computer-executable instructions to determine a resource unit index associated with a first subchannel in the first subchannel group. The at least one processor of the one or more processors may be configured to execute the computer-executable instructions to determine that the resource unit index allocates a first resource unit greater than a predetermined resource unit size. The at least one processor of the one or more processors may be configured to execute the computer-executable instructions to utilize a subchannel used by the resource unit index as part of the first resource unit. The at least one processor may be further configured to execute the computer-executable instructions to determine a subchannel configuration list of at least one of the one or more subchannels, wherein the subchannel configuration list includes a predetermined subset of used subchannels within the wireless communication channel. The wireless communication device may further include a transceiver configured to transmit and receive wireless signals. The wireless communication device may further include one or more antennas coupled to the transceiver.

According to example embodiments of the disclosure, there may be a non-transitory computer-readable medium storing computer-executable instructions which, when executed by a processor, cause the processor to perform operations. The operations may include identifying a wireless communication channel with a first device in accordance with a wireless communication standard, the wireless communication channel, comprising one or more subchannels. The operations may include identifying a high efficiency frame in accordance with a high efficiency communication standard the high efficiency frame including, at least in part, one or more high efficiency signal fields. The operations may include identifying one or more indication bits included in at least one of the one or more high efficiency fields. The operations may include determining used subchannels of the one or more subchannels based at least in part on the one or more indication bits.

Implementations may include one or more of the following features. The operations may include the one or more high efficiency signal fields include at least one of a high efficiency signal A (HE-SIG-A) field and a high efficiency signal B (HE-SIG-B) field. the computer-executable instructions cause the processor to further perform operations comprising determining a subchannel configuration list of at least one of the one or more subchannels, wherein the subchannel configuration list may include a predetermined subset of used subchannels within the wireless communication channel. The wireless communication channel may be a non-contiguous channel including one or more sub-channels. The one or more indication bits are associated with a bandwidth of the wireless communication channel. The one or more indication bits may be included in the HE-SIG-A field. The bandwidth of the wireless communication channel may include at least one of a 20 MHz, 40 MHz, 80 MHz, or 160 MHZ

In example embodiments of the disclosure, there may be a method. The method may include determining a wireless communication channel with a first device in accordance with a wireless communication standard, the wireless communication channel, comprising one or more subchannels, generating a high efficiency frame in accordance with a high efficiency communication standard the high efficiency frame including, at least in part, one or more high efficiency signal fields, determining one or more indication bits included in at least one of the one or more high efficiency fields, the one or more indication bits are associated with the one or more subchannels, and causing to send the high efficiency frame to the first device over the wireless communication channel.

Implementations may include one or more of the following features. The wireless communication channel may be a non-contiguous channel or a contiguous channel. The one or more subchannels include a primary sub-channel and one or more secondary sub-channels. The one or more high efficiency signal fields include at least one of a high efficiency signal A (HE-SIG-A) field and a high efficiency signal B (HE-SIG-B) field. The one or more indication bits indicate at least one used subchannel of the one or more subchannels within the wireless communication channel. The method may further include determining one or more resource units associated with the at least one used subchannel, and modifying the HE-SIG-B field based at least in part on one or more resource units. The method may further include determining a resource unit index associated with a first subchannel in the first subchannel group, determining that the resource unit index allocates a first resource unit greater than a predetermined resource unit size, and utilizing a subchannel used by the resource unit index as part of the first resource unit. The method may further include determining a subchannel configuration list of at least one of the one or more subchannels, wherein the subchannel configuration list may include a predetermined subset of used subchannels within the wireless communication channel.

In example embodiments of the disclosure, there may be an apparatus. The apparatus may include means for determining a wireless communication channel with a first device in accordance with a wireless communication standard, the wireless communication channel, comprising one or more subchannels. The apparatus may include means for generating a high efficiency frame in accordance with a high efficiency communication standard the high efficiency frame including, at least in part, one or more high efficiency signal fields. The apparatus may include means for determining one or more indication bits included in at least one of the one or more high efficiency fields, the one or more indication bits are associated with the one or more subchannels. The apparatus may include means for causing to send the high efficiency frame to the first device over the wireless communication channel.

Implementations may include one or more of the following features. The wireless communication channel is a non-contiguous channel or a contiguous channel. The one or more subchannels include a primary sub-channel and one or more secondary sub-channels. The one or more high efficiency signal fields include at least one of a high efficiency signal A (HE-SIG-A) field and a high efficiency signal B (HE-SIG-B) field. The one or more indication bits indicate at least one used subchannel of the one or more subchannels within the wireless communication channel. Operations further comprising means for determining one or more resource units associated with the at least one used subchannel, and means for modifying the HE-SIG-B field based at least in part on one or more resource units. Operations further comprising determining a resource unit index associated with a first subchannel in the first subchannel group, determining that the resource unit index allocates a first resource unit greater than a predetermined resource unit size. The apparatus may include utilizing a subchannel used by the resource unit index as part of the first resource unit. Operations may further include means for determining a subchannel configuration list of at least one of the one or more subchannels, wherein the subchannel configuration list includes a predetermined subset of used subchannels within the wireless communication channel.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A wireless communication device, comprising:
at least one memory that stores computer-executable instructions; and
at least one processor of the one or more processors configured to access the at least one memory, wherein the at least one processor of the one or more processors is configured to execute the computer-executable instructions to:
determine a wireless communication channel with a first device in accordance with a wireless communication standard, the wireless communication channel, comprising one or more subchannels;
generate a high efficiency frame in accordance with a high efficiency communication standard the high efficiency frame including, at least in part, one or more high efficiency signal fields;
determine one or more indication bits included in at least one of the one or more high efficiency fields, the one or more indication bits are associated with the one or more subchannels; and
cause to send the high efficiency frame to the first device over the wireless communication channel.

2. The wireless communication device of claim 1, wherein the wireless communication channel is a non-contiguous channel or a contiguous channel.

3. The wireless communication device of claim 2, wherein the one or more subchannels include a primary sub-channel and one or more secondary sub-channels.

4. The wireless communication device of claim 1, wherein the one or more high efficiency signal fields include at least one of a high efficiency signal A (HE-SIG-A) field and a high efficiency signal B (HE-SIG-B) field.

5. The wireless communication device of claim 1, wherein the one or more indication bits indicate at least one used subchannel of the one or more subchannels within the wireless communication channel.

6. The wireless communication device of claim 4, wherein the at least one processor is further configured to execute the computer-executable instructions to:
determine one or more resource on units associated with the at least one used subchannel; and
modify the HE-SIG-B field based at least in part on one or more resource units.

7. The wireless communication device of claim 1, wherein the at least one processor is further configured to execute the computer-executable instructions to:
determine a resource unit index associated with a first subchannel in the first subchannel group;
determine that the resource unit index allocates a first resource unit greater than a predetermined resource unit size; and
utilize a subchannel used by the resource unit index as part of the first resource unit.

8. The wireless communication device of claim 1, wherein the at least one processor is further configured to execute the computer-executable instructions to determine a subchannel configuration list of at least one of the one or more subchannels, wherein the subchannel configuration list includes a predetermined subset of used subchannels within the wireless communication channel.

9. The wireless communication device of claim 1, further comprising a transceiver configured to transmit and receive wireless signals.

10. The wireless communication device of claim 9, further comprising one or more antennas coupled to the transceiver.

11. A non-transitory computer-readable medium storing computer-executable instructions which, when executed by a processor, cause the processor to perform operations comprising:
identifying a wireless communication channel with a first device in accordance with a wireless communication standard, the wireless communication channel, comprising one or more subchannels;
identifying a high efficiency frame in accordance with a high efficiency communication standard the high efficiency frame including, at least in part, one or more high efficiency signal fields;
identifying one or more indication bits included in at least one of the one or more high efficiency fields; and
determining a used subchannels of the one or more subchannels based at least in part on the one or more indication bits.

12. The non-transitory computer-readable medium of claim 11, wherein the one or more high efficiency signal fields include at least one of a high efficiency signal A (HE-SIG-A) field and a high efficiency signal B (HE-SIG-B) field.

13. The non-transitory computer-readable medium of claim 11, wherein the computer-executable instructions cause the processor to further perform operations comprising determining a subchannel configuration list of at least one of the one or more subchannels, wherein the subchannel configuration list includes a predetermined subset of used subchannels within the wireless communication channel.

14. The non-transitory computer-readable medium of claim 11, wherein the wireless communication channel is a non-contiguous channel including one or more sub-channels.

15. The non-transitory computer-readable medium of claim 11, wherein the one or more indication bits are associated with a bandwidth of the wireless communication channel.

16. The non-transitory computer-readable medium of claim 12, wherein the one or more indication bits are included in the HE-SIG-A field.

17. The non-transitory computer-readable medium of claim 15, wherein the bandwidth of the wireless communication channel includes at least one of a 20 MHz, 40 MHz, 80 MHz, or 160 MHz.

18. A method comprising:
determining a wireless communication channel with a first device in accordance with a wireless communication standard, the wireless communication channel, comprising one or more subchannels;
generating a high efficiency frame in accordance with a high efficiency communication standard the high efficiency frame including, at least in part, one or more high efficiency signal fields;
determining one or more indication bits included in at least one of the one or more high efficiency fields, the one or more indication bits are associated with the one or more subchannels; and
causing to send the high efficiency frame to the first device over the wireless communication channel.

19. The method of claim 18, wherein the wireless communication channel is a non-contiguous channel or a contiguous channel.

20. The method of claim 18, wherein the one or more subchannels include a primary sub-channel and one or more secondary sub-channels.
